(19) United States
(12) Patent Application Publication
(10) Pub. No.: US 2006/0031746 A1
(43) Pub. Date: Feb. 9, 2006

(54) Publishing architecture system and method

(76) Inventors: John R. Toepfer, Chicago, IL (US); Noah Menikoff, Chicago, IL (US)

Correspondence Address: BARNES & THORNBURG, LLP, P.O. BOX 2786, CHICAGO, IL, 60690-2786, US

(21) Appl. No.: 10/901,408

(22) Filed: Jul. 27, 2004

Related U.S. Application Data
(63) Continuation of application No. 09/710,463, filed on Nov. 10, 2000, now abandoned.
(60) Provisional application No. 60/164,904, filed on Nov. 11, 1999.

(51) Int. Cl. G06F 17/21

(52) U.S. Cl. 715/500

(57) ABSTRACT

A publishing architecture system and method for importing data into a document from one or more data sources. Content can be imported into the document from one or more content libraries. Content libraries may include libraries native to the architecture system as well as those that reside in external applications. Documents created using the publishing architecture system and method can be previewed and edited. The data sources which are used to import data to the documents are maintained by the respective entity responsible for the data contained in the source. Maintenance of the data source eliminates the need to edit the data source. Additionally, content libraries are also kept up to date and may not need to be edited in the document created using the system and method. The system and method allows the user to prepare the document and decide whether to edit the document.

This application claims priority under 35 U.S.C. §119(e) to U.S. Provisional Application Ser. No. 60/164,904 filed Nov. 11, 1999, which is expressly incorporated herein by references.

### BACKGROUND AND SUMMARY OF THE INVENTION

The present invention relates generally to publishing architecture systems and methods of producing documents embodying print or electronic entities. The present invention relates more specifically to a publishing architecture system and method which separates content preparation, editing and maintenance activities from format design, editing and finalization activities in which documents are created by extracting data from data sources and content from content libraries.

Typically, a substantial degree of coordination is required for an entity such as an organization, corporation or government agency which produces a data-intense document. For example, for a large corporation to produce an accurate, up-to-date financial document, often there must be substantial collaboration between several different departments in the corporation. This is because oftentimes a document will contain, or at least will rely upon, numerical values for which a specific department is responsible. For example, if the legal department of a corporation were to produce a document relating to the previous year's profits and the current year's budget, the legal department may have to coordinate efforts with the accounting department and the marketing department of the corporation to obtain and verify the numerical data necessary to generate the document.

When a corporation produces a document, typically all document preparation and pre-press tasks are handled within desktop publishing system files. Initially, the document preparation team reviews prior versions of the document to determine what information (i.e., data and content) is needed to update the document. Then, spreadsheets are sent from respective departments to the document preparation team and/or a copy of the previous version of the document is circulated for hand mark-up. Data provided to the document preparation team by hand markup or spreadsheet is then hand entered (or pasted) into the previous version. of the document. The updated document is then distributed for proofreading to ensure accuracy, and all changes are manually entered and coordinated into a final version of the document. Then, the final version of the document is distributed for final review, and a routing sheet is often used to coordinate document sign-offs. Finally, the final, approved version of the document is either printed to PDF for web site display, or manually converted to HTML.

The present invention replaces an entirely manual effort of gathering document changes and having a desktop publishing system operator keyboard the changes into the previous version of each document. Using prior art techniques, paper drafts are circulated for additional hand markup and review. The final product (document) is thus made print-ready, however any electronic output to the web is secondary or unrelated primary process.

Where other information systems are involved in the business effort that the present invention is introduced to, those information systems are typically custom facilities that approach only one aspect of the broader business problem addressed by the present invention. For instance:
a) Content Management systems can be fielded to manage editorial processes, the importing of data into documents, and output to web-sites, but these tools typically do not support professional print output of the same materials. (except of course where custom extensions or integrations are added to the product)
b) Document Management system can sometimes manage the workflow and document assembly functions required to support print or web-output, but they do not typically provide the data gathering, data rendering, and content transformation facilities provided by the present invention.
c) Publishing tools which can support professional print, and sometimes web-output typically require that all content and data be prepared and approved before being handed off to the composition and output engine.

The present invention is directed to effectively streamline the production of documents.

An object of an embodiment of the present invention is to provide a publishing architecture system and method which provides that accurate data-driven documents can be efficiently produced.

Another object of an embodiment of the present invention is to provide a publishing architecture system and method which effectively eliminates, or at least reduces, the manual mark-up, paper routing and the re-keying of content and data which is typically associated with document production.

Still another object of an embodiment of the present invention is to provide a publishing architecture system and method which provides that data is automatically loaded into a document from one or more data sources.

Briefly, and in accordance with at least of the foregoing objects, the present invention provides a publishing architecture system and method which provides that data is imported into a document from one or more data sources. Content may also be imported into the document from one or more content libraries. Such content libraries may include libraries native to the invention as well as those that may reside in external application. Then, the document is previewed and possibly edited. Preferably, the one or more data sources from which data is imported has been kept up-to-date by the respective corporate department or person who is responsible for the data contained therein. As a result, preferably the data contained in the document need not be edited. Additionally, preferably the one or more content libraries from which content is imported has also been kept up-to-date by the respective corporate department or person who is responsible for the content contained therein. As a result, preferably the content contained in the document also need not be edited. Regardless, the document preparer may edit the format of the document. Once the document has been approved, the document may be published either in print format or electronic format.

Additional features and advantages of the invention will become apparent to those skilled in the art upon a consideration of the following detailed description of a preferred embodiment exemplifying the best mode of carrying out the invention as presently perceived.

### BRIEF DESCRIPTION OF THE DRAWINGS

The present invention and the advantages thereof will become more apparent upon consideration of the following detailed description when taken in conjunction with the accompanying drawings of which:

FIG. 1 is a flow chart which illustrates a typical production process for publishing a document containing data;

FIG. 2 is another flow chart which illustrates a document production process which is in accordance with an embodiment of the present invention;

FIG. 3 is a diagram showing the system and method of present invention which provides an overview of the architecture and capabilities thereof;

FIG. 4 is an example of a power form display; and

FIG. 5 is an example of a notepad display.

### DESCRIPTION

The present invention provides a publishing architecture system which makes document production easier and more efficient. The system provides that documents are produced by importing data which is kept in one or more data sources. Essentially, the system provides that instead of a document having to be created “from scratch” with respect to numerical values and text content contained in the document, data sources are kept up to date by corresponding departments or other entities, and then when a document is created, these data sources are accessed and data is imported in the document. As a result, accurate, up-to-date documents can be created quickly and easily without substantial co-ordination between several different departments or entities and the corresponding potential delay and cost is decreased.

The present invention provides an on-line environment for planning, editing, and managing the process of preparing recurringly-produced complex documents. The purpose of this is to improve the speed, efficiency and cost of production of document that are challenging to produce. A unique aspect of this invention is that it encompasses a variety of the complex processes and functions that lead up to the final output event. The processes include:
1. Document Planning—Establishing the structure of a document (set) and creating business rules to manage variations between documents
2. Content Management—Managing libraries of content and data with regard to access, effectivity, and output formatting.
3. Data gathering—Accessing corporate data sources and selecting data that appears as content or on which business rules are established
4. Workflow—Managing the process by which content creators or approvers access and complete their units(s) of work related to a document (set)
5. Output Management—Rendering documents and content into an output format either ready to display (i.e. HTML) or in a manner suitable to further handling (i.e. files tagged for print composition)

These capabilities cross the borders between several different types of tools and thus the system provides a communications infrastructure that is typically built as a custom extension to an existing tool. The achievement is then the creation of a highly flexible off-the-shelf infrastructure component supporting a diverse set of business process and communications goals.

The present invention will be used by groups that as a course of their business, produce large volumes of data-driven and/or cyclically produced documents. The tool can be utilized in various types of organizations and business departments to manage a variety of complex document production challenges. For example, financial services companies due to the nature of their business require comprehensive communication of financial data, statistics, marketing, and legal information to clients and to regulators. Additionally, the invention may be used in legal departments as a language management system that will assemble legal documents based on data-driven criteria. In most cases, the tool will become a centerpiece of work and procedures for the entire organization to which it is deployed.

The present invention is a very adaptable infrastructure that can be shaped to suit the needs of a wide variety of document types for different business groups and industries. What the invention is not, at this point, is a platform for creating one-off or ad-hoc documents.

The system and method of the present invention are built upon standard platforms for software engineering, databases, and content encoding. Specifically, all underlying code for the system and method is native to the Java programing language (versions 1.1 and 1.2) and compilers as available from Sun Microsystems (http://java.sun.com) for free download and royalty-free use and as incorporated herein by reference. This development platform enables users skilled in the art to rapidly and efficiently develop application software and to easily “port” the application between operating system platforms. For example, one skilled in the art, having the system and method architecture of the present invention as set forth in the present description can develop the invention under Windows NT and then, based on know techniques easily make the application operate on various Unix based platforms.

The present invention encodes and manages most content in formats based on the Extensible Markup Language (XML) standards. These standards, as published by the W3C standards body and as incorporated herein by reference, provide for flexible and open architectures for describing content. The system and method of the present content is not defined against a specific XML Document Type Definition (DTD) but is considered well structured and adherent to the concept of the standard.

Finally, the system and method of the present invention makes substantial use of relational databases to manage the meta-data that allows the system to store, extract, combine, render and output documents and document components. System access, security, and workflow functions are also managed in objects stored in this meta-data database. The present invention can utilize most any commercially available SQL-based relational database such as provided by Oracle Corporation or Microsoft Corporation and as incorporated herein by reference, to support this meta-data requirement.

A publishing architecture system in accordance with the present invention is based on a philosophy that information and processes are most efficient when they are specialized. Specifically, the architecture provides that content is kept separate from format, and content editing is kept separate from formatting efforts. This approach provides that documents can be produced with reduced amounts of repetitive, manual, time consuming and costly efforts.

Preferably, the publishing architecture system provides that users can access documents and document components on-line and simultaneously, data can be loaded into documents without being manually marked or re-keyed, content can be shared between documents and thus changes to content only need to be made once, paper-based document routing and markup strategies can be eliminated, costs can be saved, efficiencies achieved and providing final document publishing that is a highly automated process wherein print and web documents are created simultaneously.

The data sources from which the publishing architecture system imports data may be one or more system files, documents or databases that provide raw data. The data can be presented tabularly, graphically, or descriptively (i.e. mixed with text). In any case, preferably the data is considered or characterized as data and is managed accordingly.

The content libraries from which the publishing architecture system imports content may be one or more databases of language, graphics and other materials which are to be included in the resulting document. Preferably, the content libraries store language in a format-neutral manner to provide output flexibility. For example, the content libraries may store language in XML (extensible Markup Language)—a manner of encoding content so that its structure can be understood and formatting can be applied as needed. XML is considered to be the successor to the current common language (i.e. HTML) used to present information on the web as it provides more control and flexibility in information handling.

The publishing architecture system provides that components are logical units of content. A component may be a piece of a single document which should be treated as a unit. A component may be any collection of language, data, charts, etc. The publishing architecture system provides that a document is an ordered collection of components presented in a given format. In fact, to a degree, documents and components are the same. Typically, documents are simply larger collections of components with more specific display and output parameters.

In a system in which a document is a collection of components, document approval may be a multi-tiered effort, wherein specialists (i.e. individuals and/or departments) responsible for any piece or element of information in the document, must first approve their respective elements. Then, those responsible for the document on the whole must approve the complete document.

Preferably, the publishing architecture system provides that a “virtual document” can be produced, where a “virtual document” is an on-line assemblage of a document allowing content owners (i.e. individuals and/or departments responsible for the content of the document) and document owners (i.e. individuals and/or departments wanting to produce the document) to preview the document and connect to editorial, tracking, and approval tools.

Preferably, the publishing architecture system provides that when the document is published, it is transformed from a format-neutral virtual existence, to a finished presentation form. This finished presentation form may be a document or file which can be used to produce a HTML web-page, a Quark document (destined for print), and/or for use with other publishing platforms which are available or to be developed and with which the publishing architecture system is or can be made compatible.

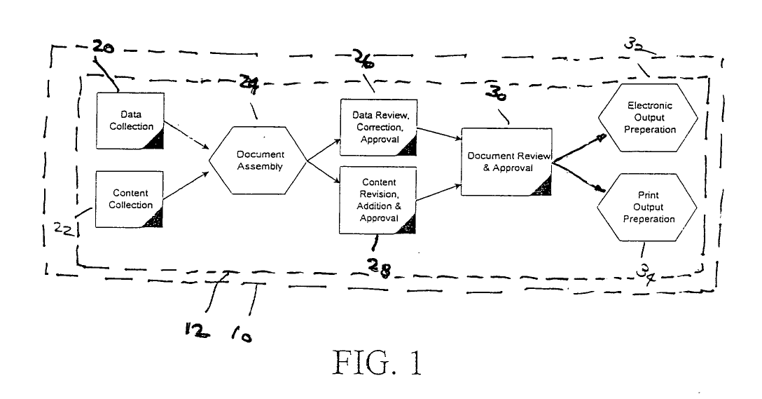

The flow chart illustrated in FIG. 1 shows a typical production process or method and a system of the present invention for publishing data-driven documents, and can be used to understand both traditional incumbent processes and the process that a publishing architecture system in accordance with the present invention creates. A computer 10 and software 12 is shown diagrammatically in FIG. 1. It should be noted that the computer 10 is generally identified and should be broadly construed. It should be understood that the computer 10 may be but need not be a single physical device and may be a network, the Internet, an intranet, or any number of devices connected to achieve the method of the system if the present invention. The following table compares these two.

| | | Publishing Architecture |
|---|---|---|
| Process Name | Traditional Techniques | Techniques |
| Data Collection | Either spreadsheets are sent to the | Data is pulled directly from |
| (20) | document preparation team or the | company databases. The system |
| | previous document version is | and method provides forms for |
| | circulated for hand markup. | validated data entry when |
| | | information is not found in |
| | | databases. |
| Content | Content (language, data, and | Content is stored at the |
| Collection (22) | graphics) are found in the word | component level in a specialized |
| | processing files used for | content database. Language is |
| | previous iterations of a | created in a basic word- |
| | document or group of | processing application presented |
| | documents. | directly within the web browser. |
| | | Application of content to |
| | | documents is handled |
| | | automatically based on business |
| | | rules established in advance. |
| Document | Document files are persistent | The system and method language |
| Assembly (24) | and are re-edited for each | and data into Components and |
| | iteration. Little real content | Documents. Language sharing is |
| | sharing takes place and edits | automatic. Documents are |
| | must be made distinctly for each | presented for review and |
| | document file. | approval within the browser |
| Data Review, | Data provided by hand markup | Updated data is automatically |
| Correction, | or spreadsheet is hand entered | included in documents. When |
| Approval (26) | (or pasted) into the document | data requires manual review or |
| | production tool. Documents are | input, specialized forms are |
| | circulated on paper multiple | presented for data owners to |
| | times for proof reading to | update and approve the material. |
| | ensure accuracy. | |
| Content | Document files or paper are | Individuals are responsible for |
| Review, | passed around for users to enter | specific material within the |
| Addition & | revisions and new language. | documents and many users can |
| Approval (28) | All changes must be manually | perform their changes |
| | entered and coordinated into the | simultaneously directly into the |
| | final document. | system. No re-keying is |
| | | required. |
| Document | Documents are passed around in | Final document review and |
| Review and | paper form for multiple cycles | approval takes place on-line. |
| Approval (30) | of final review. A routing sheet | Comments and questions can be |
| | is often used to coordinate | appended to materials |
| | document sign-offs. | |
| Electronic | Documents are either printed to | HTML documents are produced |
| Output | PDF for web site display, or | automatically based once the |
| Preparation | manually converted to HTML. | on-line virtual document is |
| (32) | | approved. |
| Print Output | All document preparation and | Complete documents are |
| Preparation | pre-press tasks are handled | published into the pre-press |
| (34) | within desktop publishing | composition tool desired in an |
| | system files. All changes are | automated process. Only minor |
| | manually handled and multiple | final cleanup and proofing |
| | proofing cycles are required to | efforts are required. |
| | ensure errors were not | |
| | introduced. | |

A publishing architecture system in accordance with the present invention achieves flexibility in process control and output due to two key system design strategies:

1) Document content is removed from the traditional file-based desktop tools. This is advantageous because, among other reasons, managing documents in MS Word, Quark, and other such tools means that only one person can control the master document file at once and the output is limited to the abilities of that tool; and

2) Document content is broken into logical components and preferably encoded in XML. Each component can be shared, re-used, owned, validated and processed separately. Final document production is achieved by assembling appropriate components (and possibly converting the language the content is in (i.e. XML) into an appropriate output format (i.e. Quark, HTML, InDesign, etc.)).

A publishing architecture system in accordance with the present invention puts most of the content control and processing burden on a server, and a “thin” client supports all required user activities and then the output tools of choice are applied to create final document output.

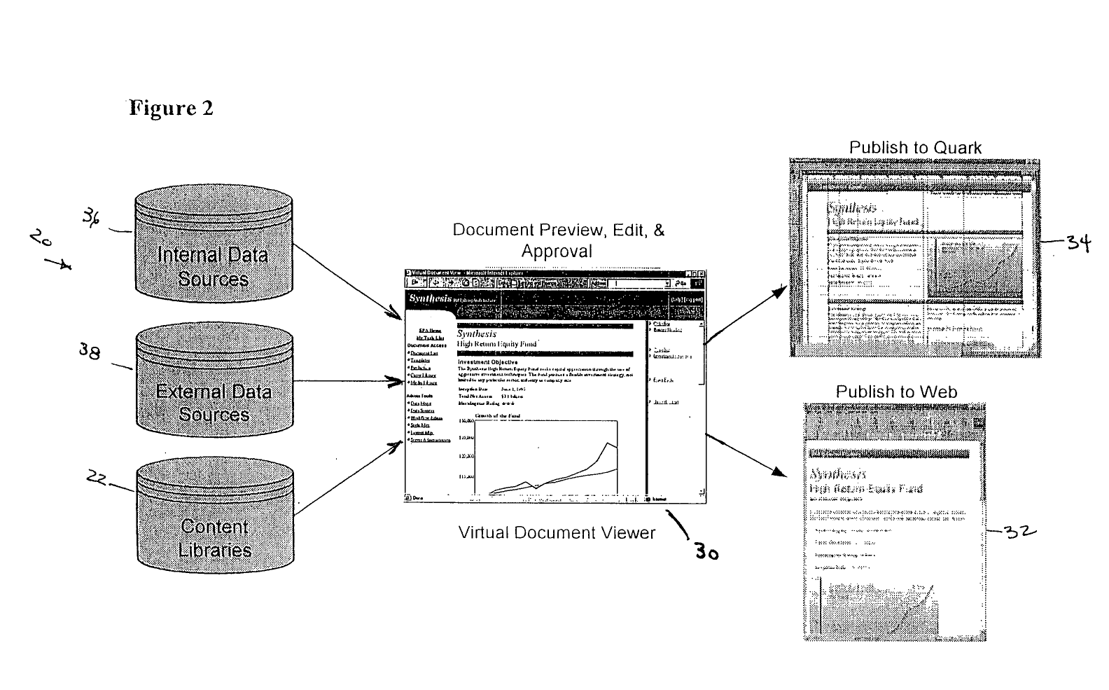

The diagram illustrated in FIG. 2 describes, in relatively basic terms, how this process appears to the end user of the system. Users see virtual documents, finished documents, and the workflow process, but are not specifically aware of the complexities of content and data handling that drive the process.

The client user interface, which is preferably entirely browser-based, allows users to perform all required tasks without taking control of a single master file. This browser user interface may be referred to as the “Virtual Document Viewer” (30) and preferably supports functions such as:
Viewing and HTML representation of documents in process;
Creating, editing and revising both text and data (numbers);
Viewing personal work queues and document processing task lists;
Planning new documents and Components; and
Commenting on and approving Components and documents.

Preferably, the publishing architecture system is configured to provide the ability to share the workload of processing a document between the client application and the server. This means that specialized processes are in place to support each phase of document preparation. Only those facilities that require user involvement are presented to users. All other processing services are handled on the server without user involvement.

The virtual document viewer 30 can use data from internal services 36. External sources 38 and content libraries 40. These documents can be published, for example, to print output format 34 such as Quark or electronic output format such as the Web 32.

The following lists describe the functionality as it is preferably distributed between the client and server:

Client

Virtual (draft) Document Display
Language and Data Editing
Document and Component Approval User Interface
Document and Component Planning User Interface
Process/workflow reporting User Interface
System Administration User Interface
   Server
Data gathering and formatting
Content storage and retrieval
Document and component assembly
Document and component formatting
Workflow management
Graph rendering
Time and event-based processing
Content change control and tracking
Security
Integration with additional systems (such as Document Management and composition tools)

Preferably, the publishing architecture system provides that users can collaboratively participate in a document preparation effort through simultaneously performing the specialized tasks that are required to create or update a document.

The publishing architecture system is preferably based on a set of component tools developed expressly for use in publishing systems. For example, in the present preferred embodiment, each component is Java-based and can be deployed on many different platforms and in a wide variety of configurations.

It should be noted that such systems are constantly changing and new systems being developed. It should be appreciated that the present invention is intended to be fully compatible with publishing systems which may not yet be available. This is because the invention stores language in a format neutral manner. Preferably, the system includes the following components:

Transaction Server

The Transaction Server or TS is an Internet application server which is essentially the foundation of the publishing architecture system, and functions as a universal server managing all client-server and server-server transactions required by the system. Preferably, the TS manages workflow events, data extraction operations, file serving requests, document build/publish events and many other transaction types.

All features and functions are registered as transactions with the TS and the server then manages communications, server resources task queuing, and task prioritization. The TS is built as low overhead highly scalable server that will maximize the processing capabilities of the server on which it is installed.

Preferably, the TS is equipped to handle synchronous, asynchronous, console, and time-scheduled transactions, and can even be implemented as a stand alone HTTP server. Implementation of the TS involves installing the base software classes and then creating new transaction classes to support the work to be accomplished.

Preferably, as the TS is used in support of high capacity real-time systems, it is designed around a very low overhead multi-threaded processing model. Preferably, the number of processing threads the TS can support related to the number of processing threads the server, on which it is installed, can handle, and provides priority-based queuing to support transactions requests in excess of this limit. Depending on processor speed, transaction latency (time to from transaction request to start) can be less than one millisecond.

The TS preferably employs an advanced caching model that allows the system to store the results of transactions and simply return pointers to cached objects when redundant transaction requests are received. A base set of transaction objects that enable the TS to interact with the other components of the system is preferably provided with the server.

Data Mapper

This utility provides a gateway to the various data sources that need to be linked into the publishing system, and can be used, for example, to coordinate gathering material from accounting databases, sales systems, data warehouses, document/text management systems, and even flat file data sources. Preferably, the resulting data stream is encoded as a structured object that can be handed off to whatever processing engine will be handling the data.

A Data Map is essentially a parameterized SQL query that is stored along with database access information and additional processing information. Data Maps are often serialized such that the results of one query create the parameters for a following query. The output of these operations can be cached as structured data objects managed by a Transaction Manager or loaded back into a database table for further processing.

The Data Mapper is preferably designed around a validation engine that supports both data testing and post processing of query results. This validation facility can be used to re-format data, re-organize the data set, and to test the data set against processing rules. The Data Mapper can preferably ODBC/JDBC protocols, or native drivers to access any variety of data sets or sources and then presents the data in a structured object model for rendering, output, or editing via the power form. Implementation of this tool involves installing the base software classes and then simply creating new data map objects to support the environment and work to be accomplished. The TS may be used to coordinate the work of the Data Mapper, however the tool can also be called via its own API.

Power Form

The power form tool is a browser-based tool providing a user interface to create and edit almost any data set. An example of a power form display is provided in FIG. 4. Working in conjunction with the data mapper, the power form has the ability to recognize the structure of a data set and automatically configure itself to present the data in an editable spreadsheet form. Additionally, the data mapper and power form can work together to validate entered data and to present pick-lists allowing users to select from approved values rather than keyboarding content. The power form can also be used to support data entry activities thus allowing IT teams to reduce their need to build custom front-end applications for data gathering operations.

Notepad

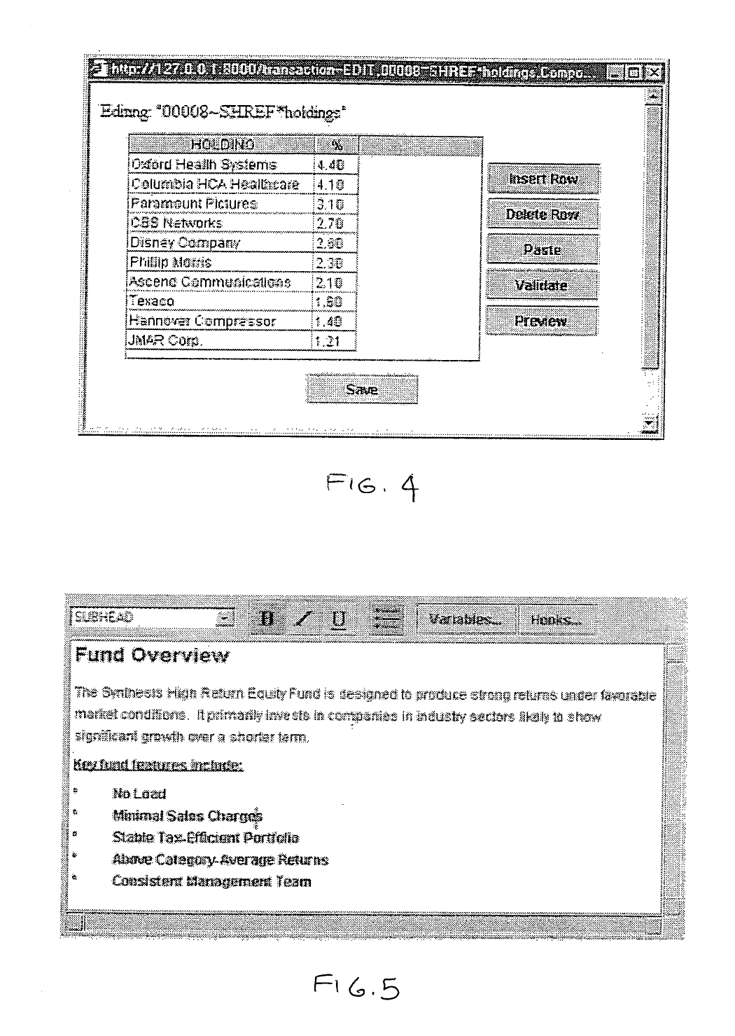

The notepad provides actual word-processing abilities within a web page and not merely providing text editing boxes on an HTML form. FIG. 5 is an example of a note pad display. The notepad is a unique tool which allows a user to edit text content directly through the browser. This applet allows users to enter multiple paragraphs of text and lists and to apply named “styles” to this content. Styles can incorporate font, size, paragraph and color information. The pallet of styles available to users is managed by the style manager and thus the environment ensures that the content created will be compatible with all of the system output renderers. Users can also easily embed variable data and links to endnote materials using simple pick-lists provided in menus.

Graph Building Utility (hereinafter “GBU”)

Especially where large quantities of data are concerned, documents often display the information in chart form. GBU provides both interactive and automatic chart rendering tools that produce professional quality output for both print and web site use.

Preferably, GBU supports pie charts, bar charts, line charts and most other presentations used in financial documents, and the appearance of the charts can be entirely customized. GBU preferably outputs high quality GIF and EPS images for use in both print and electronic publications. Preferably, GBU can be implemented as either a user interactive tool for developing charts or as a batch facility (managed by the TS) to render charts and graphs with no user intervention.

Document Builder

Publishing architecture system documents are collections of the data, text, and graphics managed by the system. The Document Builder handles the document assembly, on-line draft presentation, and delivery of the content to pre-press and web-site facilities.

In other words, the Document Builder performs the task of evaluating and collating text, graphics, and data components into a whole document. The construction of a document may include simple or complex inclusion and exclusion rules. Document components may be shared between documents to streamline the user involvement in the production process. The Document Builder preferably constructs a text-encoded object that can be passed to users for review, approval, and editorial through a fully customizable workflow. The output rendering module of the Document Builder is the system component (to be described more fully later herein) that enables the system to function as a publishing system. Documents built by the Document Builder can be translated and formatted to support any tag-driven or structured composition or viewing tool. In particular, documents can be published into HTML format, Xtag format for importing into Quark, and many proprietary formats to source third-party composition engines. While web-site presentation may require no additional processing, the Document Builder may be integrated with Quark or other tools providing a composition of documents destined for print production.

A key feature of the document builder is the ability to update a rendered document with changed content without re-building the entire document from scratch. Whereas the initial assembly of a document (including building and rendering content and data) may require 10-60 seconds or more, when a single piece of the document (a component) changes, the document can be “refreshed” and display this change in as little as 3 seconds. This ability to selectively rebuild a document and to manage the conditions which determine what components need to be re-built at any time is a key operating feature and advantage of this system.

Virtual Document Viewer (hereinafter “VDV”)

Preferably, the user interface for the Document Builder is a browser-based facility known as the Virtual Document Viewer (“VDV”). Using this tool, documents can be configured, previewed on-line and even edited via the power forms and notepad. Rather than creating new proprietary user interface applications that must be installed and supported on the user's desktop, the VDV provides all user interface facilities for the system from within a web-browser. Document planning, viewing, editing, workflow, and system administration functions are all supported from this interface.

Regardless of the components of the system which are utilized, preferably the architecture provides that content is kept separate from format, and that content editing is kept separate from formatting efforts. This approach provides that documents can be produced with reduced amounts of repetitive, manual, or time consuming efforts.

Attached hereto as an Appendix is additional information about the present invention. Specifically, information (i.e. “Publishing Architecture”) is attached hereto further describing aspects of the present invention, information (i.e. “SPA Support for Variable Data Publishing”) is attached hereto describing an application of the present invention relating to variable data publishing, and information (i.e. “E-Commerce Solution Toolkit”) is attached hereto describing an application of the present invention relating to electronic commerce.

Examples of the benefits and advantages of the system and method of the present invention when applied to document production challenges are:
1) Reduces time to market for document by 40% or more
2) Reduces number or revision and review cycles for pre-press and on-press proof materials
3) Automatically integrates data from corporate databases into document content
4) Automatically produces data presentation (tables & charts) directly from source data
5) Automatically loads document content into common professional desktop publishing tools
6) Provides an on-line preview of documents in process (within the web browser)
7) Supports output of documents to print and to web based on the same content tools and procedures
8) Allows content editing directly within the browser
9) Allows content to be shared between documents
10) Allows process (workflow) to be assigned to individuals and groups variably based on attributes of documents and product attributes
11) Does not require physical distribution or installation of any proprietary software on user's desktops workstations.

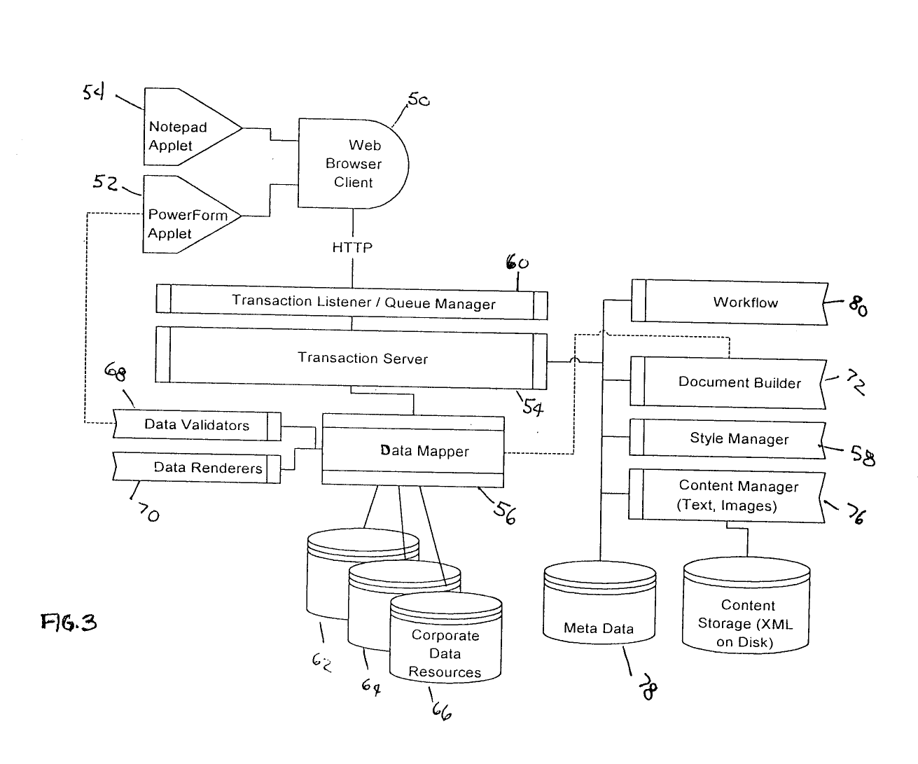

FIG. 3 is a diagram showing the system and method of present invention which provides an overview of the architecture and capabilities thereof. As shown in FIG. 3, the system includes a web browser client 50 providing a web browser user interface. The web browser client is based on a Microsoft Internet explorer 4 or comparable Netscape browser. The web browser client 50 handles HTML forms, DHTML and Java applets. The web browser client 50 provides all user interface system administration function and includes document content access and viewing (security controlled), editorial functions (word processing and spreadsheets), workflow planning (content/document review and approval) document planning (document structures and business logic) content planning (content structures and business logic) data access (matching data sources and data based queries), and system administration (users, groups, logs, security). The web browser client provides stateless interaction with the transaction server 54 and thus each form access or submit function is validated for security and validity. The average interface response time for web browser 50 interactions with the transaction server 54 is approximately 0.5 seconds.

The applet 52 is Java 1.1 based and runs on Microsoft Internet Explorer Version 4 or higher or comparable Netscape or other platform. This is a Java-based spreadsheet application that supports validated data entry functions. Working in conjunction with the data validation classes associated with a data mapper 54 the applet 52 can provide validation for format and content of numerical cells and columns, as well as providing pick lists to assist to entering text fields. The applet 52 downloads as an auto-installing applet at run time and uses the web browsers' native Java 1.1 virtual machine.

The notepad applet 54 is also Microsoft Internet Explorer Version 4 or higher based as well as a comparable alternative web browser. This applet 54 is a “basic styles-driven” word processing application designed to work with a web browser. It allows a user to enter multiple paragraphs of text (including lists) and apply named “styles” to the content by way of a style manager 58. Additional functionality includes support for imbedded variables, support for cross references, support for special characters. A transaction listener/queue manager 60 is coupled to the web browser client 50 and the transaction server 54. The manager 60 is based on any Java 1.1 certified vm (for example, as currently deployed under Windows NT4). The manager 60 is the input output management facility for the system. It “listens” on various communication channels including HTTP, Sockets and Console channels for server transaction request. When requests are received, it either spawns a processor thread and launches the requested transaction or queue the request to await system resources. Spawned threads are given processing priorities appropriate to the transaction. Large or background transactions are prioritized at a lower level to allow user interactive operations to proceed quickly.

As noted above, a transaction server 54 is provided. The transaction server employs the same platform as the manager 60. The server 54 provides a central registry of available transactions and manages all interactions between transactions. Transactions that are registered with the server can serve basically any programmatically achievable function and are located and registered dynamically at server startup time. The standard set of user interface tools and forms are rendered and managed by the server 54. The server is equipped with a transaction scheduler which allows both processing and maintenance functions to be registered for execution at a given time or on a repeating schedule.

The data mapper similarly is based on the Java 1.2-type platform as noted above for the transaction server 54 and manager 60. The data mapper 56 provides facilities to store and execute SQL commands. It supports both PL SQL (as provided by Oracle Corporation) platforms as well as Transact SQL (SQL server & Sybase) platforms. It's data source manager allows multiple corporate databases 62, 64, 66 to be registered with the system. A data map may be used to collect data supporting document template decisions and document content decisions and to provide data that is presented in a document. Data maps can coordinate, select, insert, update and delete functions and can support complex queries and references to data-based stored procedures. Results from the data mapper 56 can be passed through one or more validators 68 or renderers 70 in order to achieve testing, post-processing and formatting effects.

The data renderers 70 are based on the same Java 1.2 platform or other suitable platform as indicated above. The renderers 70 are the principal means by which the system may be customized to effect the appearance of material to suit the exact requirements of a client. Most text formatting results and many basic data rendering results may be achieved by standard system features, renderers 70 provide the availability to take the return set of data mapped query from the data mapper 56 and present it in a highly specialized manner. A variety of standard renderers 70 are provided with the system. Specialty 70 renderers 70 are written in Java on a client's specific basis to support custom data representations including full color charts and graphs. While a library of standard renderers 70 can be compiled, it is desirable to move the renderer design tools into user interface controls. This would reduce the amount of custom code written on a per client basis.

A document builder 72 provides a core functionality that allows the system to be presented as publishing platform. The document builder 72 assembles documents and components from source materials and produces a rendered output of the material. This effort requires transforming components (natively stored as XML) into a tagged output (presentation) format. Hence, XML is transformed into HTML for presentation on a web site and into XPress Tags for loading into a Quark Express document for pre-press operations. This effort also requires acting upon “inclusion criteria” that have been established at the component template level and in copy groups. The document builder 72 also manages the cache of document and components as well as sharing of component between documents. The goal is to optimize the sharing of materials and to minimize component refresh/rebuild activities. Either when assembled into a document, each component is tracked with relation to the activities in the system. If a user takes an action that may impact a component, that material is marked as “expired” and will be rebuilt before it is again presented or used. This re-building takes place at the component level, thus allowing the minimal amount of work and time before a document can be presented with updated component content.

Style Manager 58 is tightly coupled with the Document Builder 72. Using the Style Manager 58, named “Styles” can be created and formatting (tagging) instructions particular to each style and each output format can be described. The Document Builder 72 references the Style Manager 58 when transforming XML content for output or display. The Notepad applet 54 references the Style Manager 58 to make content styles available to users when creating language content.

Content Manager 76 is also based on Java 1.2 as noted hereinabove with regard to other portions of the system. The Content Manager 76 supports the storage and maintenance of all objects created and managed by the system. Language content, data sets, XML objects, rendered components and graphics are all managed as system resources by this facility. As with all modules of the system, the Content Manager interacts substantially with a meta-data database 78. Additionally, the Content Manager interacts with the servers file system. For performance and capacity reasons the system maintains all content objects in secure directories on the file system.

The meta-data database 78 is based on a platform using SQL Server 7X, Oracle 7X, Oracle 7X. Oracle 8, Oracle 8i and other similar commercially available databases. The meta-data database 78 can be located on the server with the application or across a high-capacity network segment on a dedicated database server. This database houses the schema (approximately 40 tables) supporting all object identification, access and control meta-data for the system.

A workflow module 80 is also based on a Java 1.2 platform as discussed in greater detail hereinabove with regard to other modules. The workflow module 80 supports assigning of work flow patterns to each document component in the system. Each type of component may have a different workflow pattern in each instance of a component may be routed to different individuals while following the pattern. Workflow functions are tightly related to the system's internal “virtual document” presentation of document or component. At all times, the current workflow status of each piece of the document is represented and tools are provided for users to easily access and approve materials in the system. The workflow module is also integrated with e-mail notification transactions that allow user's personal “task lists” to be pushed out on a recurring schedule.

Although the invention has been described in detail with reference to a preferred embodiment, variations and modifications exist within the scope and spirit of the invention as described and defined in the following claims.

1. A system for planning, editing and managing the process of recurringly-produced complex documents employing a computer and software operated at least in part by said computer for selecting at least one of data and content, assembling said at least one data and content into a document, providing independent display and control of data and content, combining data and content into a document, reviewing and approving said document, and outputting the finalized document into at least one of electronic output format and print output format.

2. A system for use with a computer to plan, edit and manage the process of recurringly-produced complex documents said system comprising: means for selecting at least one of data and content, means for assembling said at least one data and content into a document, means for independently displaying and controlling data and content, means for combining data and content into a document, means for reviewing and approving said document, and means for outputting the finalized document into at least one of electronic output format and print output format.

3. A method of planning, editing and managing the process of recurringly-produced complex documents said method comprising the steps of: selecting at least one of data and content, assembling said at least one data and content into a document, independently displaying and controlling data and content, combining data and content into a document, reviewing and approving said document, and outputting the finalized document into at least one of electronic output format and print output format.

4. A system for planning, editing and managing the process of recurringly-produced complex documents employing a computer and software operated at least in part by said computer, a data collection module from which data can be selected and a content collection module for selecting content, a document assembly module coupled to said data collection module and coupled to said content collection module for assembling said data and said content into a document, a data review module coupled to said data assembly module for independently displaying and controlling data from said document assembly module, a content review module coupled to said data assembly module for independently displaying and controlling content from said document assembly module, a document review and approval module coupled to said data review module and coupled to said content review module for combining data and content into a document and reviewing and approving said document, and at least one of an electronic output module and a print output module.
